(19) United States
(12) Patent Application Publication
(10) Pub. No.: US 2026/0080401 A1
(43) Pub. Date: Mar. 19, 2026

(54) SENSITIVE DATA PROTECTION

(71) Applicant: Visa International Service Association, San Francisco, CA (US)

(72) Inventors: Brendan Xavier Louis, Manteca, CA (US); Glenn Leon Powell, South Jordan, UT (US); Geoffrey Brookman, Highlands Ranch, CO (US)

(73) Assignee: Visa International Service Association, San Francisco, CA (US)

(21) Appl. No.: 18/896,066

(22) Filed: Sep. 25, 2024

Related U.S. Application Data
(60) Provisional application No. 63/586,805, filed on Sep. 29, 2023.

(51) Int. Cl. G06Q 20/40; G06Q 20/38

(52) U.S. Cl. CPC G06Q 20/40; G06Q 20/382

(57) ABSTRACT

A computer-implemented method for generating a non-payment referent associated with payment data related to a payment account is disclosed. The computer-implemented method includes receiving, by a payment network, a message from an issuer, wherein the message includes payment data relating to a payment account, wherein the payment data is used as a payment instrument; generating, by the payment network, a non-payment referent associated with the payment data based on the payment network receiving the payment data for a first time, wherein the non-payment referent is not a payment instrument; and sending, by the payment network, a correlation message to the issuer, wherein the correlation message includes the payment data and the non-payment referent, and wherein the correlation message is configured to inform the issuer that the non-payment referent is associated with the payment data.

### CROSS-REFERENCE TO RELATED APPLICATION

This application claims the benefit of and priority under 35 U.S. C. § 119 (e) to U.S. Provisional Application Serial No. 63/586,805 filed September 29, 2023, entitled “SENSITIVE DATA PROTECTION,” the contents of which is hereby incorporated by reference in its entirety herein.

### TECHNICAL FIELD

The following disclosure relates generally to various methods and systems for providing a sensitive data protection service to clients that obfuscates sensitive cardholder information before client use, or storage, to achieve Payment Card Industry Data Security Standard (PCI DSS) compliance.

### SUMMARY

In part, in one aspect, the present disclosure relates to a computer-implemented method for generating a non-payment referent associated with payment data related to a payment account. The computer-implemented method includes receiving, by a payment network, a message from an issuer, the message including payment data relating to a payment account, the payment data is used as a payment instrument; generating, by the payment network, a non-payment referent associated with the payment data based on the payment network receiving the payment data for a first time, the non-payment referent is not a payment instrument; and sending, by the payment network, a correlation message to the issuer, the correlation message including the payment data and the non-payment referent, and the correlation message is configured to inform the issuer that the non-payment referent is associated with the payment data.

In part, in one aspect, the present disclosure relates to a computer-implemented method for authorizing or declining a transaction based on a non-payment referent associated with payment data related to a payment account. The computer-implemented method includes receiving, by a payment network, a first authorization request message from an acquirer, the first authorization request message including payment data relating to a payment account, and the payment data is used as a payment instrument; sending, by the payment network, a second authorization request message to an issuer, the second authorization request message including a non-payment referent associated with the payment data, and the non-payment referent is not a payment instrument; receiving, by the payment network, a first authorization response message from the issuer, the first authorization response message authorizing or declining the transaction, and the first authorization response message including the non-payment referent; and sending, by the payment network, a second authorization response message to the acquirer, the second authorization response message authorizing or declining the transaction, and the second authorization response message including the payment data.

In part, in one aspect, the present disclosure relates to a payment network system for generating a non-payment referent associated with payment data related to a payment account and authorizing or declining a transaction based on the non-payment referent. The payment network system includes a server computer including a processor and a memory coupled to the processor, the memory storing thereon machine executable instructions that when executed cause the processor to receive a message from an issuer, the message including payment data relating to a payment account, the payment data is a payment instrument; generate a non-payment referent associated with the payment data based on the processor receiving the payment data for a first time, the non-payment referent is not a payment instrument; send a correlation message to the issuer, the correlation message including the payment data and the non-payment referent, and the correlation message is configured to inform the issuer that the non-payment referent is associated with the payment data; receive a first authorization request message from an acquirer, the first authorization request message including the payment data; send a second authorization request message to the issuer, the second authorization request message including the non-payment referent; receive a first authorization response message from the issuer, the first authorization response message authorizing or declining the transaction, and the first authorization response message including the non-payment referent; and send a second authorization response message to the acquirer, the second authorization response message authorizing or declining the transaction, and the second authorization response message including the payment data.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates an authorization message flow, according to at least one aspect of the present disclosure.

FIG. 2 illustrates a Single Message Service (SMS) full financial service clearing and settlement message flow, according to at least one aspect of the present disclosure.

FIG. 3 illustrates a computer-implemented method for generating a non-payment referent associated with payment data related to a payment account, according to at least one aspect of the present disclosure.

FIG. 4 illustrates a computer-implemented method for authorizing or declining a transaction based on a non-payment referent associated with payment data related to a payment account, according to at least one aspect of the present disclosure.

FIG. 5 is a block diagram of a computer apparatus with data processing subsystems or components, according to at least one aspect of the present disclosure.

FIG. 6 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. In a general sense, account credentials may be static or dynamic such that they may change over time. Further, in some embodiments or aspects, the account credentials may include information that is both static and dynamic. For example, an account identifier and expiration date may be static but a cryptogram may be dynamic and change for each transaction. Alternatively, a cryptogram may be static. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “account credential,” “account number,” or “payment credential” may refer to any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

An “authorization request message” may be an electronic message that is sent to a payment processing network and/or an issuer of a payment account to request authorization for a payment transaction. An authorization request message according to some embodiments or aspects may comply with International Organization for Standardization (ISO) 8583, which is a standard for systems that exchange electronic transaction information associated with a payment made by a consumer using a payment device or a payment account. An ISO 8583 message includes a message type indicator, one or more bitmaps indicating which data elements are present in the message, and data elements of the message. The authorization request message may include an issuer account identifier that may be associated with a payment device or payment account. An authorization request message may be generated by an acceptance device or a server and may be sent to an issuing financial institution directly or through a payment network. In some embodiments or aspects of the present disclosure, an authorization request message may include a payment token, an expiration date, a token presentment mode, a token requestor identifier, a token cryptogram, a token assurance level, and data used to generate the token assurance level. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, for example, a service code, a CVV or CVC (card verification value or code), a dCVV or dCVC (dynamic card verification value or code), token cryptogram, an expiration date, etc. An authorization request message may also comprise “transaction information,” such as any information associated with a current transaction (e.g., the transaction amount, merchant identifier, merchant location, etc.) as well as any other information that may be utilized in determining whether to identify and/or authorize a payment transaction.

An “authorization response message” may be an electronic message reply to an authorization request message generated by an issuing financial institution (e.g., issuer) or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may include an authorization code, which may be a code that an account issuing bank returns in response to an authorization request message in an electronic message (either directly or through the payment processing network) to the merchant's access device (e.g., POS terminal) that indicates approval of the transaction. The code may serve as proof of authorization. As noted above, in some embodiments or aspects, a payment processing network may generate and/or forward the authorization response message to the merchant.

A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card. A digital wallet may include an interface for displaying a PAN associated with a payment card loaded onto the digital wallet.

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “primary account number (PAN)” may be a variable length, (e.g., 13 to 19-digit) industry standard-compliant account number that is generated within account ranges associated with a BIN by an issuer.

As used herein, a “secure element” may include a secure computer memory in an electronic device capable of storing sensitive data or applications. A secure element may, but need not be, physically isolated from other memory in an electronic device. A secure element may comprise, or may be contained within, a hardware security module, a software security module, or other mechanism providing for secure and controlled access to the data stored within it. A secure element may further comprise a dedicated crypto-processor used for accessing its contents and executing secure operations.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like).

One of the largest challenges for financial technology companies, as well as neobanks, is developing technology for use within their payment processing businesses that is Payment Card Industry Data Security Standard (PCI DSS) compliant. In a general sense, PCI DSS compliance requires that financial technology companies obfuscate sensitive information relating to a cardholder. More specifically, PCI DSS compliance requires that Primary Account Information (PAI), such as a primary account number (PAN), and Personally Identifiable Information (PII), such as a cardholder’s name, date of birth, etc., are obfuscated before any such financial technology company may use, or store, the information. Developing any such solution is complex and costly for each financial technology company. Accordingly, there is a need for a widespread solution that may be used by various financial technology companies, such as those using VisaNet developed by Visa, for example.

Several existing payment flows used by financial technology companies currently transmit PAI and PII as-is without any form of obfuscation. That is, any such cardholder’s PAN, name, date of birth, etc. is transmitted without being obfuscated. Thus, in order to establish PCI DSS compliance, financial technology companies are responsible for ensuring that the PAI and PII is obfuscated in-house upon receipt from a payment network. As stated above, developing any such solution is complex and costly for each financial technology company. Thus, the present disclosure provides a widespread solution that obfuscates the PAI and PII before a payment network, such as VisaNet developed by Visa, transmits the information to any such financial technology company. As a result, financial technology companies using the solution disclosed herein establish PCI DSS compliance without having to develop their own complex, costly solution.

Before use, the disclosed solution must first be implemented by the payment network in the card generation process. This occurs when an issuer, also referred to herein as a financial technology company, sends instructions to a third party (such as a card management system) to create a new card for any such user. After receiving instructions from the issuer to create a new card, the third party must then reach out to the payment network, such as VisaNet developed by Visa, to register the new card with the payment network. At this point, a PAI reference (e.g., a PAN reference) is generated by the payment network, which is permanently associated with the PAI (e.g., the PAN) of the new card, and which is sent to the issuer without the issuer ever knowing the PAI (e.g., the PAN) of the new card. That is, the PAI is obfuscated before the issuer may use, or store, the information. Similarly, PII, such as a cardholder’s name, date of birth, etc., is also obfuscated before the issuer may use, or store, the information. As a result, issuers using the solution disclosed herein may establish PCI DSS compliance without having to develop their own complex, costly solution to obfuscate PAI and PII in-house.

Now, with respect to the figures, a detailed description of the sensitive data protection service is provided below.

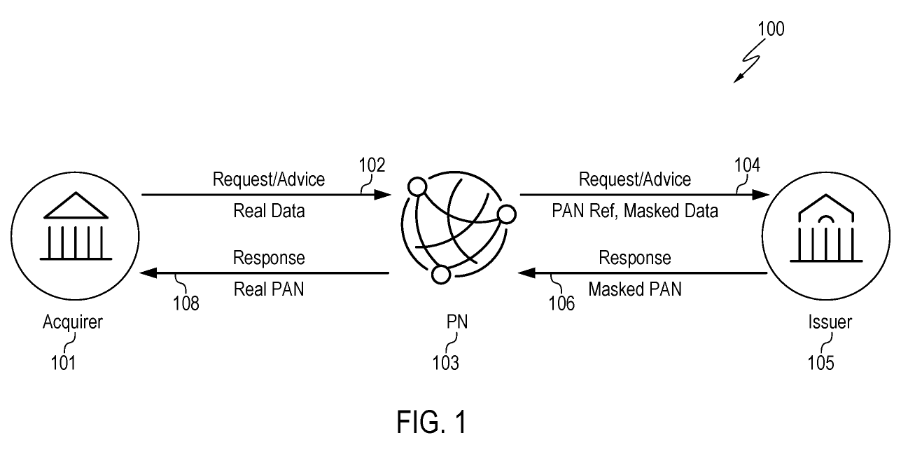

FIG. 1 illustrates an authorization message flow 100, according to at least one aspect of the present disclosure. The authorization message flow 100 can include an acquirer 101 sending an authorization request message 102 to a payment network 103. The authorization request message 102 can include real data, such as, for example, Primary Account Information (PAI) and Personally Identifiable Information (PII) associated with a payment account for which the acquirer 101 is requesting funds. Specifically, the PAI can include a Primary Account Number (PAN) associated with a card used for the transaction, and the PII can include at least one of a name, a date of birth, or the like of a cardholder associated with the card used for the transaction. Next, upon receipt of the authorization request message 102, the payment network 103 can determine the reference data from an in-house database, such as, for example, at least one PAI reference corresponding to the PAI and obfuscated data corresponding to the PII. Specifically, the at least one PAI reference can include a PAN reference corresponding to the PAN associated with the card used for the transaction, and the obfuscated data can correspond to at least one of the name, the date of birth, or the like of the cardholder. As described above, the reference data (e.g., the PAN reference) can be generated and permanently associated with the real data (e.g., the PAN) during a card generation process. Next, the payment network 103 can send an authorization request message 104 to an issuer 105, which can include the reference data. Upon receipt of the reference data, the issuer 105 can authorize, or decline, the transaction based on a confirmation that the cardholder’s card has sufficient funds, or credit. Additional steps may be required for authorization, such as two-factor authentication (2FA), though examples are not so limiting. Following authorization of the transaction, the issuer 105 can then send an authorization response message 106 to the payment network 103, which can include the reference data. Following receipt of the authorization response message 106, the payment network 103 can determine the real data (e.g., the PAN) that is associated with the received reference data (e.g., the reference PAN). Finally, the payment network 103 can send an authorization response message 108, which can include the real data, to the acquirer 101. Upon receipt of the authorization response message 108 by the acquirer 101, the transaction can be authorized and completed.

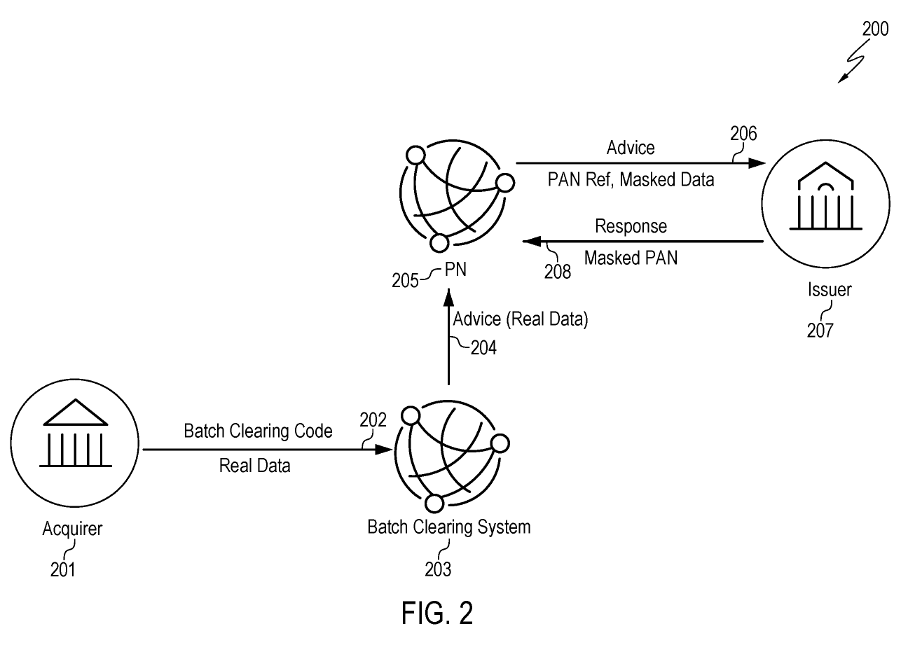

FIG. 2 illustrates a Single Message Service (SMS) full financial service clearing and settlement message flow 200, according to at least one aspect of the present disclosure. The SMS full financial service clearing and settlement message flow 200 can begin with an acquirer 201 sending 202 real data, such as, for example, Primary Account Information (PAI) and Personally Identifiable Information (PII), as well as a batch clearing code (e.g., a transaction certificate (TC) code) to a real-time batch clearing system 203 (e.g., a settlement interface (RSI)). Specifically, the PAI can include a Primary Account Number (PAN) associated with a card used for a transaction, and the PII can include at least one of a name, a date of birth, or the like of a cardholder associated with the card used for the transaction. From here, the batch clearing system 203 can send 204 the real data to the payment network 205. Upon receipt of the real data, the payment network 205 can then determine the reference data from an in-house database, such as, for example, at least one PAI reference corresponding to the PAI and obfuscated data corresponding to the PII. Specifically, the at least one PAI reference can include a PAN reference corresponding to the PAN associated with the card used for the transaction, and the obfuscated data corresponds to at least one of the name, the date of birth, or the like of the cardholder. As described above, the reference data (e.g., the PAN reference) can be generated and permanently associated with the real data (e.g., the PAN) during a card generation process. Next, the payment network 205 can send 206 the reference data to an issuer 207. Upon receipt of the reference data, the issuer 207 can authorize the clearing and settlement, and, in turn, can send 208 a response including the reference data back to the payment network 205.

As one having ordinary skill in the art would appreciate, the implementation of the sensitive data protection service disclosed herein with respect to FIG. 1 is similar to the implementation of the sensitive data protection service disclosed herein with respect to FIG. 2. Namely, for both message flows, the PAN is not known by the issuer for any transaction, except for an initial transaction that triggers the generation of reference data at the payment network. This is beneficial for a number of reasons. First, the solution disclosed herein obfuscates the PAI and PII before transmitting such information to the issuer. Thus, the issuer need not develop their own complex, costly solution to obfuscate the PAI and PII in-house before use, or storage, to meet PCI DSS compliance. Additionally, by obfuscating the PAI and PII at the payment network, the risk of fraudulent activity is greatly reduced. Since the PAI and PII is obfuscated, namely the PAI (e.g., the PAN), any hacker that may intercept the authorization request message may only obtain the PAI reference (e.g., the PAN reference), not the PAI (e.g., the PAN). However, the PAI reference is simply a reference that holds no transactional value. That is, any hacker that may intercept the PAI reference will not be able to use the PAI reference for completing transactions. Rather, the PAI reference is simply a reference associated with the PAI at the payment network. Further to this point, if an employee of the issuer is attempting to steal a cardholder’s information, they will only obtain the PAI reference. As stated above, the PAI reference is unable to be used for completing transactions. As a result, the solution disclosed herein spares issuers from having to develop complex, costly solutions to obfuscate PAI and PII in-house, while further providing an extra layer of security to prevent possible fraudulent transactions.

Although the present disclosure relates generally to an aliasing technique, those having ordinary skill in the art will appreciate the key features that differentiate the solution disclosed herein from standard aliasing techniques. First, the reference data (e.g., the PAN reference) cannot be used for completing transactions. If a fraudulent user obtains the reference data and attempts to complete a transaction using the reference data, the transaction will be declined as the reference data holds no transactional value. This is different from standard aliasing techniques, where obtained encrypted tokens may be decrypted and used to complete fraudulent transactions by a user should they also obtain the key(s) necessary for decryption. Second, standard aliasing techniques are used for encrypting/decrypting the real data (e.g., the PAN). That is, for standard aliasing techniques, the issuer receives the encrypted message, which includes the real data, and decrypts the encrypted request. Thus, for standard aliasing techniques, the issuer knows the real data during the authorization message flow. This is different than the solution disclosed herein as the real data is unknown to the issuer for all transactions, except for an initial transaction that triggers the generation of reference data at the payment network. Rather, only the reference data is known to the issuer during the authorization message flow according to the present disclosure. As a result, the solution disclosed herein provides various novel features that spare issuers from having to develop their own complex, costly solutions to obfuscate PAI and PII in-house, while providing added levels of security to prevent possible fraudulent transactions.

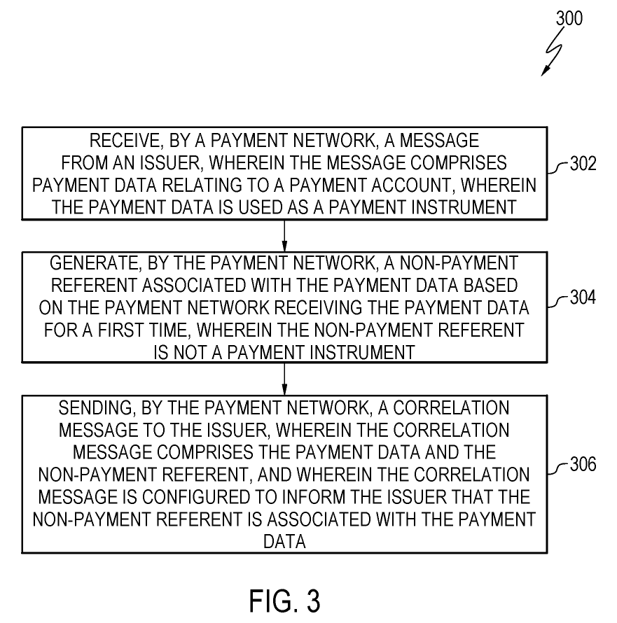

FIG. 3 illustrates a computer-implemented method 300 for generating a non-payment referent associated with payment data related to a payment account, according to at least one aspect of the present disclosure. The computer-implemented method 300 can include receiving 302, by a payment network, a message from an issuer. The message can include payment data relating to a payment account, where the payment data can be used as a payment instrument. The computer-implemented method 300 can further include generating 304, by the payment network, a non-payment referent associated with the payment data based on the payment network receiving the payment data for a first time. The non-payment referent cannot be a payment instrument. The computer-implemented method 300 can further include sending 306, by the payment network, a correlation message to the issuer. The correlation message can include the payment data and the non-payment referent, and the correlation message can be configured to inform the issuer that the non-payment referent is associated with the payment data.

According to at least one aspect, the payment data cannot be included in future communication between the payment network and the issuer based on the non-payment referent being generated. That is, after the non-payment referent is generated, the payment data cannot be included in future communication between the payment network and the issuer. As a result, in the event that someone intercepts future communication between the payment network and the issuer, they are only able to obtain the non-payment referent which holds no transactional value as the non-payment referent cannot be a payment instrument.

According to at least one aspect, the non-payment referent can be permanently associated with the payment data. Stated differently, after the non-payment referent is generated based on the payment network receiving the payment data for a first time, the non-payment referent is permanently associated with the payment data.

According to at least one aspect, the payment data can include PAI, and the non-payment referent can include a PAI reference associated with the PAI. The PAI can include a PAN, and, thus, the PAI reference can include a PAN reference. The PAI can further include at least one of a CVV2 or an expiration date relating to a payment card of the payment account, and, thus, the PAI reference can include an obfuscated referent of the CVV2 or the expiration date relating to the payment card of the payment account.

According to at least one aspect, the payment data can include a payment token associated with a PAN, and the non-payment referent can include a payment token reference associated with the payment token. As stated above, the non-payment referent cannot be a payment instrument, and, thus, the payment token reference cannot hold any transactional value. Stated differently, the payment token reference cannot be decrypted and used as a payment instrument as it holds no transactional value.

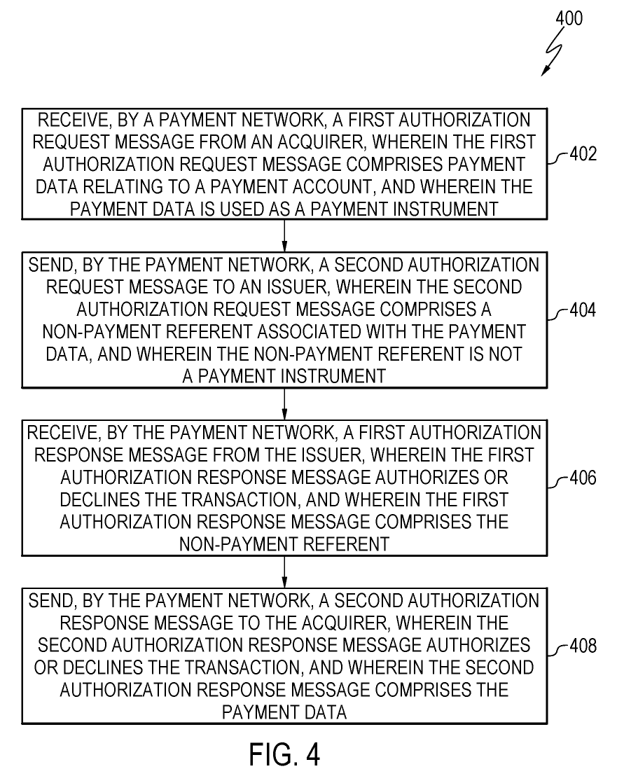

FIG. 4 illustrates a computer-implemented method 400 for authorizing or declining a transaction based on a non-payment referent associated with payment data related to a payment account, according to at least one aspect of the present disclosure. The computer-implemented method 400 can include receiving 402, by a payment network, a first authorization request message from an acquirer. The first authorization request message can include payment data relating to a payment account, where the payment data can be used as a payment instrument. The computer-implemented method 400 can further include sending 404, by the payment network, a second authorization request message to an issuer. The second authorization request message can include a non-payment referent associated with the payment data, where the non-payment referent cannot be a payment instrument. The computer-implemented method 400 can further include receiving 406, by the payment network, a first authorization response message from the issuer. The first authorization response message can authorize or decline the transaction, and the first authorization response message can include the non-payment referent. The computer-implemented method 400 can further include sending 408, by the payment network, a second authorization response message to the acquirer. The second authorization response message can authorize or decline the transaction, and the second authorization response message can include the payment data.

According to at least one aspect, the second authorization request message cannot include the payment data, and the first authorization response message cannot include the payment data. That is, the second authorization request message (e.g., from the payment network to the issuer) and the first authorization response message (e.g., from the issuer to the payment network) cannot include the payment data. As a result, in the event that someone intercepts communication between the payment network and the issuer, they are only able to obtain the non-payment referent which holds no transactional value as the non-payment referent cannot be a payment instrument.

According to at least one aspect, the non-payment referent can be permanently associated with the payment data. Stated differently, after the non-payment referent is generated based on the payment network receiving the payment data for a first time, the non-payment referent is permanently associated with the payment data.

According to at least one aspect, the payment data can include PAI, and the non-payment referent can include a PAI reference associated with the PAI. The PAI can include a PAN, and, thus, the PAI reference can include a PAN reference. The PAI can further include at least one of a CVV2 or an expiration date relating to a payment card of the payment account, and, thus, the PAI reference can include an obfuscated referent of the CVV2 or the expiration date relating to the payment card of the payment account.

According to at least one aspect, the payment data can include a payment token associated with a PAN, and the non-payment referent can include a payment token reference associated with the payment token. As stated above, the non-payment referent cannot be a payment instrument, and, thus, the payment token reference cannot hold any transactional value. Stated differently, the payment token reference cannot be decrypted and used as a payment instrument as it holds no transactional value.

Altogether, the computer-implemented methods 300, 400 of FIGS. 3 and 4, respectively, provide an example process for generating a non-payment referent associated with payment data related to a payment account and subsequently authorizing or declining a transaction based on the generated non-payment referent associated with the payment data related to the payment account. Stated differently, the computer-implemented methods 300, 400 of FIGS. 3 and 4 can be used individually or in combination with one another to provide the sensitive data protection service disclosed herein.

The aforementioned sensitive data protection service, including the systems, methods, or the like of FIGS. 1-4, can include or make use of a number of computer apparatuses, host machines, or the like. In other words, in order to implement the sensitive data protection service, at least one of a computer apparatus, host machine, or the like may be implemented. Each of the computer apparatus, host machine, or the like are described in greater detail below and provide a connection between the solution disclosed herein and how such a solution may be carried out with respect to each of the systems, methods, or the like of FIGS. 1-4.

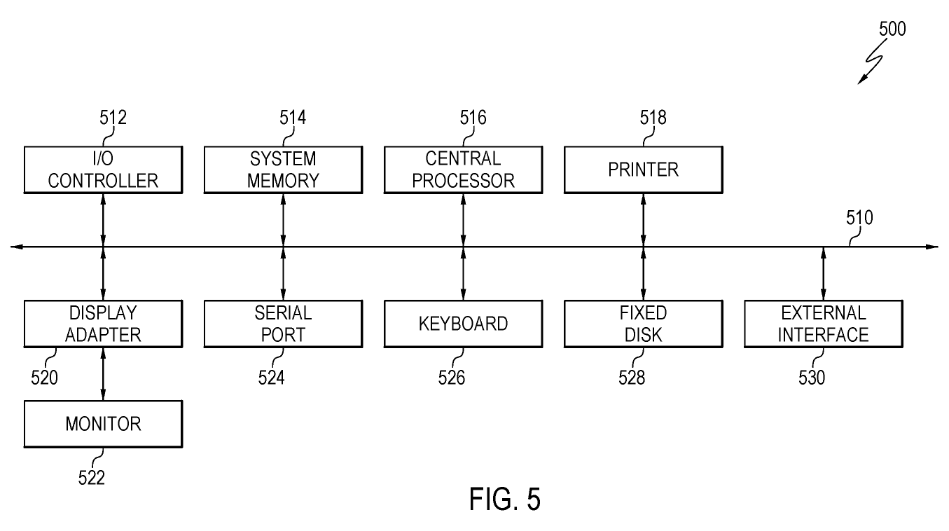

FIG. 5 is a block diagram of a computer apparatus 500 with data processing subsystems or components, according to at least one aspect of the present disclosure. The subsystems shown in FIG. 5 are interconnected via a system bus 510. Additional subsystems such as a printer 518, keyboard 526, fixed disk 528 (or other memory comprising computer-readable media), monitor 522, which is coupled to a display adapter 520, and others are shown. Peripherals and input/output (I/O) devices, which couple to an I/O controller 512 (which can be a processor or other suitable controller), can be connected to the computer system by any number of means known in the art, such as a serial port 524. For example, the serial port 524 or external interface 530 can be used to connect the computer apparatus to a wide area network such as the Internet, a mouse input device, or a scanner. The interconnection via system bus allows the central processor 516 to communicate with each subsystem and to control the execution of instructions from system memory 514 or the fixed disk 528, as well as the exchange of information between subsystems. The system memory 514 and/or the fixed disk 528 may embody a computer-readable medium.

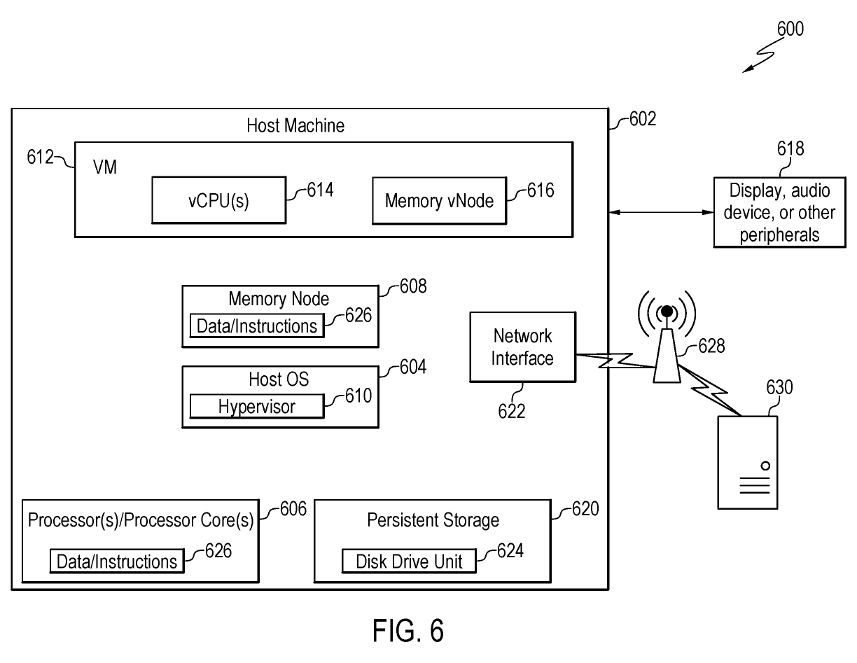

FIG. 6 is a diagrammatic representation of an example system 600 that includes a host machine 602 within which a set of instructions to perform any one or more of the methodologies discussed herein may be executed, according to at least one aspect of the present disclosure. In various aspects, the host machine 602 operates as a standalone device or may be connected (e.g., networked) to other machines. In a networked deployment, the host machine 602 may operate in the capacity of a server or a client machine in a server-client network environment, or as a peer machine in a peer-to-peer (or distributed) network environment. The host machine 602 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 600 includes the host machine 602, running a host operating system (OS) 604 on a processor or multiple processor(s)/processor core(s) 606 (e.g., a central processing unit (CPU), a graphics processing unit (GPU), or both), and various memory nodes 608. The host OS 604 may include a hypervisor 610 which is able to control the functions and/or communicate with a virtual machine (“VM”) 612 running on machine readable media. The VM 612 also may include a virtual CPU or vCPU 614. The memory nodes 608 may be linked or pinned to virtual memory nodes or vNodes 616. When the memory node 608 is linked or pinned to a corresponding vNode 616, then data may be mapped directly from the memory nodes 608 to their corresponding vNodes 616.

All the various components shown in host machine 602 may be connected with and to each other, or communicate to each other via a bus (not shown) or via other coupling or communication channels or mechanisms. The host machine 602 may further include a video display, audio device or other peripherals 618 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 620 (also referred to as disk drive unit), and a network interface device 622. The host machine 602 may further include a data encryption module (not shown) to encrypt data. The components provided in the host machine 602 are those typically found in computer systems that may be suitable for use with aspects of the present disclosure and are intended to represent a broad category of such computer components that are known in the art. Thus, the system 600 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 624 also may be a Solid-state Drive (SSD), a hard disk drive (HDD) or other includes a computer or machine-readable medium on which is stored one or more sets of instructions and data structures (e.g., data/instructions 626) embodying or utilizing any one or more of the methodologies or functions described herein. The data/instructions 626 also may reside, completely or at least partially, within the main memory node 608 and/or within the processor(s) 606 during execution thereof by the host machine 602. The data/instructions 626 may further be transmitted or received over a network 628 via the network interface device 622 utilizing any one of several well-known transfer protocols (e.g., Hyper Text Transfer Protocol (HTTP)).

The processor(s) 606 and memory nodes 608 also may comprise machine-readable media. The term "computer-readable medium" or “machine-readable medium” should be taken to include a single medium or multiple medium (e.g., a centralized or distributed database and/or associated caches and servers) that store the one or more sets of instructions. The term "computer-readable medium" shall also be taken to include any medium that is capable of storing, encoding, or carrying a set of instructions for execution by the host machine 602 and that causes the host machine 602 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 630 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 602, with each server 630 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the "C" programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method for generating a non-payment referent associated with payment data related to a payment account, the computer-implemented method comprising:
receiving, by a payment network, a message from an issuer, wherein the message comprises payment data relating to a payment account, and wherein the payment data is used as a payment instrument;
generating, by the payment network, a non-payment referent associated with the payment data based on the payment network receiving the payment data for a first time, wherein the non-payment referent is not a payment instrument; and
sending, by the payment network, a correlation message to the issuer, wherein the correlation message comprises the payment data and the non-payment referent, and wherein the correlation message is configured to inform the issuer that the non-payment referent is associated with the payment data.

2. The computer-implemented method of claim 1, wherein the payment data is not included in future communication between the payment network and the issuer based on the non-payment referent being generated.

3. The computer-implemented method of claim 1, wherein the non-payment referent is permanently associated with the payment data.

4. The computer-implemented method of claim 1, wherein the payment data comprises Primary Account Information (PAI), and wherein the non-payment referent comprises a PAI reference associated with the PAI.

5. The computer-implemented method of claim 4, wherein the PAI comprises a Primary Account Number (PAN).

6. The computer-implemented method of claim 5, wherein the PAI further comprises at least one of a card verification value (CVV2) or an expiration date relating to a payment card of the payment account.

7. The computer-implemented method of claim 1, wherein the payment data comprises a payment token associated with a Primary Account Number (PAN), and wherein the non-payment referent comprises a payment token reference associated with the payment token.

8. A computer-implemented method for authorizing or declining a transaction based on a non-payment referent associated with payment data related to a payment account, the computer-implemented method comprising:
receiving, by a payment network, a first authorization request message from an acquirer, wherein the first authorization request message comprises payment data relating to a payment account, and wherein the payment data is used as a payment instrument;
sending, by the payment network, a second authorization request message to an issuer, wherein the second authorization request message comprises a non-payment referent associated with the payment data, and wherein the non-payment referent is not a payment instrument;
receiving, by the payment network, a first authorization response message from the issuer, wherein the first authorization response message authorizes or declines the transaction, and wherein the first authorization response message comprises the non-payment referent; and
sending, by the payment network, a second authorization response message to the acquirer, wherein the second authorization response message authorizes or declines the transaction, and wherein the second authorization response message comprises the payment data.

9. The computer-implemented method of claim 8, wherein the second authorization request message does not include the payment data, and wherein the first authorization response message does not include the payment data.

10. The computer-implemented method of claim 8, wherein the non-payment referent is permanently associated with the payment data.

11. The computer-implemented method of claim 8, wherein the payment data comprises Primary Account Information (PAI), and wherein the non-payment referent comprises a PAI reference associated with the PAI.

12. The computer-implemented method of claim 11, wherein the PAI comprises a Primary Account Number (PAN).

13. The computer-implemented method of claim 12, wherein the PAI further comprises at least one of a card verification value (CVV2) or an expiration date relating to a payment card of the payment account.

14. The computer-implemented method of claim 8, wherein the payment data comprises a payment token associated with a Primary Account Number (PAN), and wherein the non-payment referent comprises a payment token reference associated with the payment token.

15. A payment network system for generating a non-payment referent associated with payment data related to a payment account and authorizing or declining a transaction based on the non-payment referent, the payment network system comprising:
a server computer comprising a processor and a memory coupled to the processor, the memory storing thereon machine executable instructions that when executed cause the processor to:
receive a message from an issuer, wherein the message comprises payment data relating to a payment account, and wherein the payment data is a payment instrument;
generate a non-payment referent associated with the payment data based on the processor receiving the payment data for a first time, wherein the non-payment referent is not a payment instrument;
send a correlation message to the issuer, wherein the correlation message comprises the payment data and the non-payment referent, and wherein the correlation message is configured to inform the issuer that the non-payment referent is associated with the payment data;
receive a first authorization request message from an acquirer, wherein the first authorization request message comprises the payment data;
send a second authorization request message to the issuer, wherein the second authorization request message comprises the non-payment referent;
receive a first authorization response message from the issuer, wherein the first authorization response message authorizes or declines the transaction, and wherein the first authorization response message comprises the non-payment referent; and
send a second authorization response message to the acquirer, wherein the second authorization response message authorizes or declines the transaction, and wherein the second authorization response message comprises the payment data.

16. The payment network system of claim 15, wherein the payment data is not included in future communication between the processor and the issuer based on the non-payment referent being generated.

17. The payment network system of claim 15, wherein the second authorization request message does not include the payment data, and wherein the first authorization response message does not include the payment data.

18. The payment network system of claim 15, wherein the non-payment referent is permanently associated with the payment data.

19. The payment network system of claim 15, wherein the payment data comprises Primary Account Information (PAI), and wherein the non-payment referent comprises a PAI reference associated with the PAI.

20. The payment network system of claim 15, wherein the payment data comprises a payment token associated with a Primary Account Number (PAN), and wherein the non-payment referent comprises a payment token reference associated with the payment token.
